(19) United States
(12) Patent Application Publication
(10) Pub. No.: US 2003/0126452 A1
(43) Pub. Date: Jul. 3, 2003

(54) Methods for protecting specific program area or data area

(76) Inventor: Zhi-Hao Lin, Taipei Hsien (TW)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/039,009

(22) Filed: Dec. 31, 2001

(51) Int. Cl. H04L 9/00

(52) U.S. Cl. 713/193

(57) ABSTRACT

The present invention provides a method for protecting a specific one of a program area and a dada area having specific usage standards to be applied to a basic input/output system (BIOS), wherein the basic input/output system defines a mapping table. The method includes steps of: providing at least one product and reading a product characteristic value of the at least one product; operating the product characteristic value through an algorithm to obtain an operation value; comparing the operation value with the mapping table to decide whether the at least one product has the characteristic value conforming to the usage standards of the specific one of the program area and the data area; and executing a protection action for the specific one of the program area and the data area when the at least one product does not have the characteristic value conforming to the usage standards of the specific one of the program area and the data area, thereby preventing the specific one of the program area and the data area from being misappropriated illegally.

### FIELD OF THE INVENTION

This invention relates to a protecting method, and more particularly to a method for protecting a specific program area or data area.

### BACKGROUND OF THE INVENTION

Because of the progress of the technology, computers are used extensively in all kinds of fields. The demands of computers are getting increased and increased, and also, the efficiency and functions of the products are required to be more and more. All these cause the industrial manufacturers to try their best to research for new products.

Nevertheless, unworthy industrial manufacturers copy, manufacture, and sell the products strenuously developed by others. Thus, how to prevent the imitation and copy of the painstaking efforts of engineers is a primary issue that all industrial manufacturers try hard to solve.

Taking motherboards as an example, different motherboard manufacturers all focus on adopting different circuit designs in the hardware of the motherboard or base on the assistance of the software to improve the efficiency and the function of the motherboards. Naturally, all these improving methods and assistant software are intellectual properties belonging to the researchers.

The software, which is developed by the manufacturer to increase the efficiency of the motherboard and improve the functions of the operating system, should be protected, too.

For dealing with the technical situation described above, the applicant keeps on carving unflaggingly to develop “the method for protecting specific program area or data area” through wholehearted experience and research.

### SUMMARY OF THE INVENTION

It is an object of the present invention to provide a method for protecting specific program area or data from being copied.

It is another object of the present invention to provide a method to reach the purpose of preventing the research result from being misappropriated illegally.

Please refer to FIGS. 1 & 2 showing the block diagrams and flow charts of the functions of a computer system adopting the method in the present invention. For the motherboards with same frameworks, every manufacturer nearly uses the same chipset, but after different disposition of circuit layout and chip pins, different product characteristic values are produced. Thus, with the product characteristic values, the present invention decides whether the at least one product conforms to usage standards of the program area or the data area.

The present invention providing a method for protecting specific program area or data is applied to basic input/output system (BIOS) 11, wherein the basic input/output system defines a mapping table 111 therein to decide whether the at least one product 12 having the right to use the specific program area or data area 13. The method comprises steps of: providing at least one product and reading a product characteristic value of the at least one product; operating the product characteristic value through an algorithm to obtain an operation value; comparing the operation value with the mapping table to decide whether the at least one product has the characteristic value conforming to the usage standards of the specific one of the program area and the data area; and executing a protection action for the specific one of the program area and the data area when the at least one product does not have the characteristic value conforming to the usage standards of the specific one of the program area and the data area, thereby preventing the specific one of the program area and the data area from being misappropriated illegally.

Preferably, the product characteristic value is obtained via reading contents of the at least one product.

Preferably, the at least one product is selected from a group consisting of a system chipset, a PCI/ISA card, a ROM, a CMOS, a CPU, a computer peripheral device, and the combination thereof.

Preferably, the system chipset is selected from a group consisting of a clock generator, a South Bridge chipset, a North Bridge chipset, a Communication chipset, a Super I/O chipset, a Video Graphics Array chipset, a small computer system interface chipset, a Local Area network chipset, a sensor chipset, a health chipset, a PCI/PCI Bridge chipset, an IDE ATA Controller chipset, a PCI/ISA Bridge chipset, a 1394 chipset, and the combination thereof.

Preferably, the PCI/ISA card is selected from a group consisting of a sound card, a TV card, a VGA card, a SCSI card, a LAN card, an IDE card, an AMR card, a CNR card, a Modem card, and the combination thereof.

Preferably, the ROM is selected from a group consisting of an EEPROM, an EPROM, a PROM, a ROM, a Flash Memory, and the combination thereof.

Preferably, the product characteristic value of the ROM is based on one data selected from a group consisting of a Checksum value, a Class code, a Sub-class code, a Revision ID, a Device ID, a Vendor ID, a Manufacturer ID, a Product ID, a Sub-Product ID, a Sub-Device ID, a Sub-Vendor ID, a ROM Signature, a Data Structure Length, a Data Structure Revision, an Image Length, a Revision Level of Code/Data, a code Type, a Command Code, a Control Register, a Status Register, an Expansion ROM Base Address, a Configuration type, a Serial Presence Detect Data, a Clockgen device related data, and a specific address data.

Preferably, the CMOS is used for storing a relevant set value of the BIOS.

Preferably, the product characteristic value is selected from a group consisting of an ID, a Patch ID, a relevant register value of the CPU, and combination thereof.

Preferably, the computer peripheral device is selected from a group consisting of a Modem, a Printer, a Serial port device, a Parallel port device, a SCSI Device, an IDE Device, a UBS Device, a Midi Device, and the combination thereof.

Preferably, the SCSI Device, the IDE Device, and the USB Device are provided by a group consisting one of a diskette, a hard disk, a compact disc, a ZIP disk, a LS-120 disk, a type, and the combination thereof.

Preferably, the product characteristic value is one selected from a group consisting of a register value, an I/O port value and the combination thereof in the at least one product.

Preferably, the algorithm is a secret code algorithm.

Preferably, the secret code algorithm is one of a summing algorithm and an operating function algorithm.

Preferably, the protecting action is to skip the specific one of the program area and the data area.

Preferably, the protecting action is to shutdown the operating system.

Preferably, the protecting action is to halt the operating system.

Preferably, the protecting action is to produce a flag signal to be stored in a storage device for protecting the specific one of the specific program area and data area.

Preferably, the program area and the data area are stored in a storage module.

Preferably, the operation value is one of a specific value and a supplemental value.

In accordance with an aspect of the present invention, a method for protecting a specific one of a program area and a dada area to be applied to a basic input/output system (BIOS), wherein the basic input/output system defines a mapping table therein. The method comprising steps of: providing at least one product and reading a product characteristic value of the at least one product; comparing the product characteristic value with the mapping table to decide whether the at least one product has the characteristic value conforming to usage standards of the specific one of the program area and the data area; and executing a protection action for the specific one of the program area and the data area when the at least one product does not have the characteristic value conforming to the usage standards of the specific one of the program area and the data area, thereby preventing the specific one of the program area and the data area from being misappropriated illegally.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIGS. 1 is a functional block chart of a computer system adopting the method for protecting the specific program area or data according to the present invention;

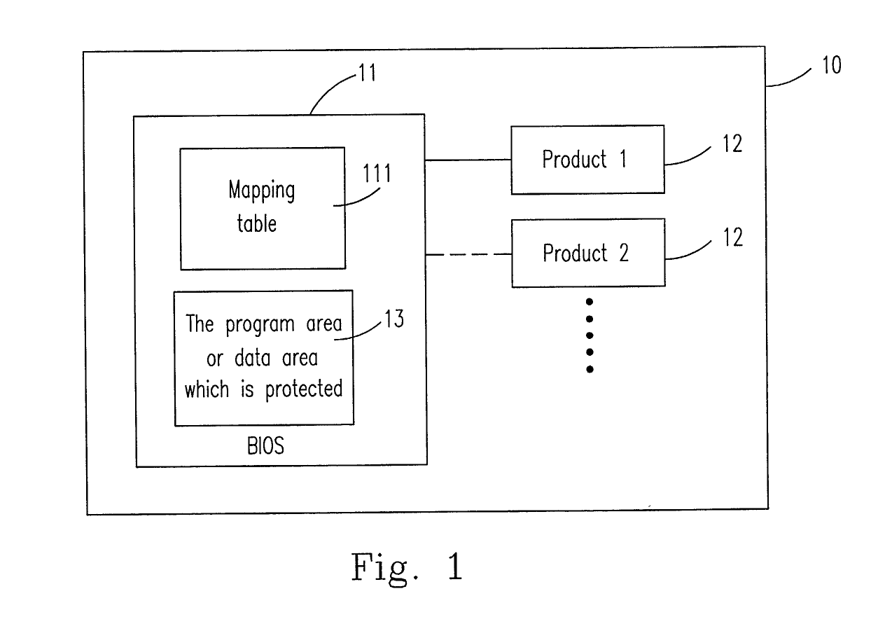

FIG. 2 is a general flow chart according to the present invention;

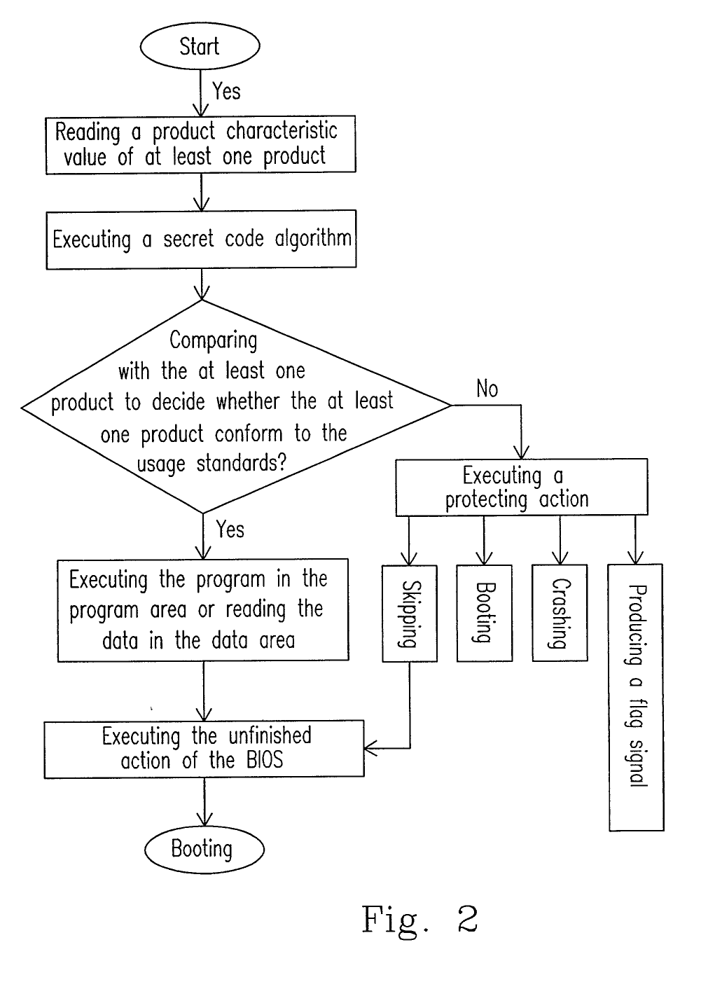

FIG. 3 is a flow chart of a first preferred embodiment according to the present invention;

FIG. 4 is a flow chart of a second preferred embodiment according to the present invention; and

FIG. 5 is a flow chart of a third preferred embodiment according to the present invention.

### DETAILED DESCRIPTION OF THE PREFERRED EMBODIMENT

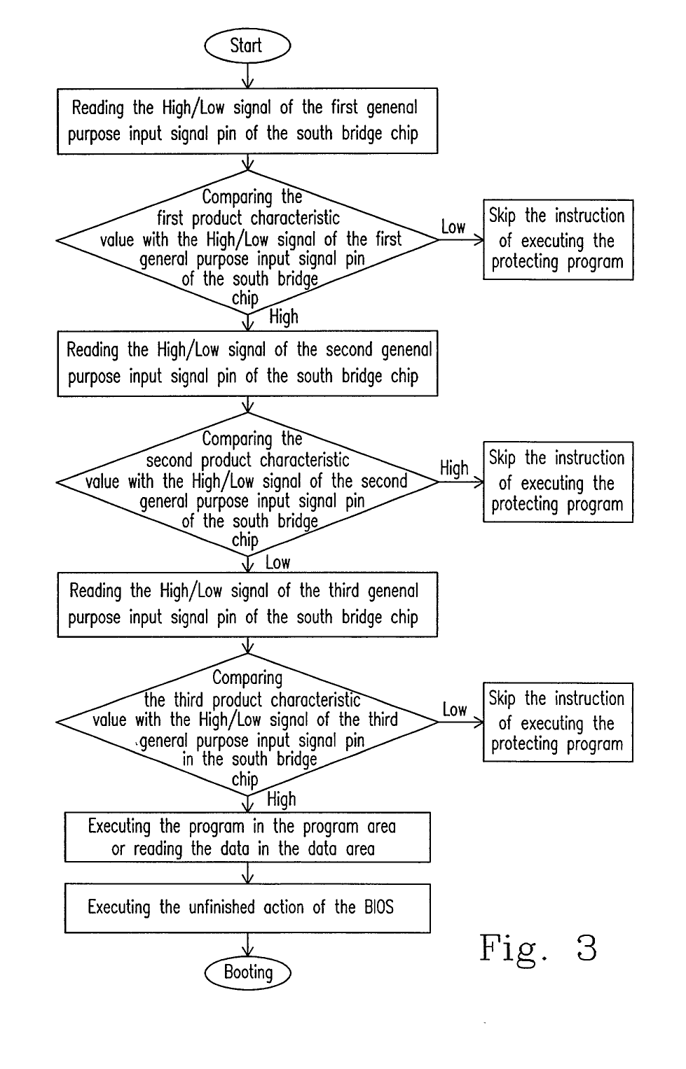

Please refer to FIG. 3 showing the flow chart of the first preferred embodiment according to the present invention. This embodiment reads the High/Low signal of the general purpose input signal pin in the different pin of the South Bridge chip, wherein High is 1 and Low is 0, and the value (1,0,1) in the mapping table defined in the BIOS is compared one by one to decide whether the product has the characteristic value conforming to the usage standards. If the first, second, or third product characteristic values do not conform to the usage standards, the instructions of the protected specific program area or data area will be skipped.

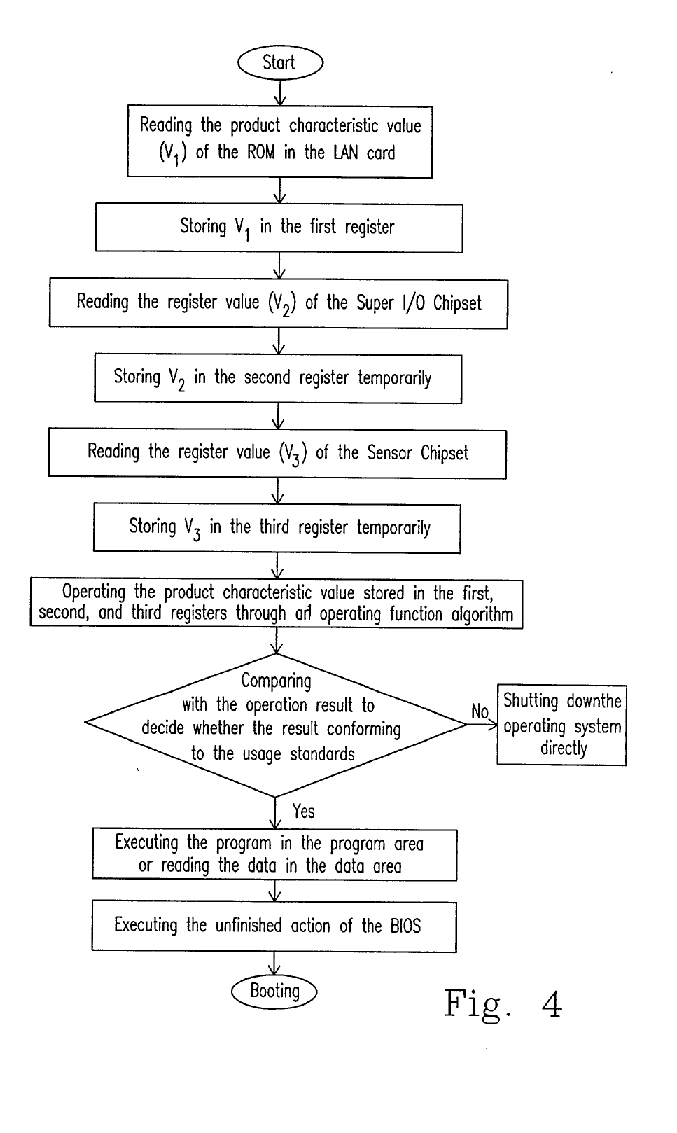

Please refer to FIG. 4 showing the flow chart of the second preferred embodiment according to the present invention. This embodiment shows values read sequentially in the LAN card. The values above include the checksum value of the ROM V₁=01A9, the device ID of the input/out chipset V₂=00D2, and the device ID of the sensor chipset V₃=00C1, and all these values are stored in a register separately. Then, all the product characteristic values in the register are executed with an operating function algorithm to obtain the operation result X=(((V₁−3)*2+(V₂+5)*V₃/(V₁+V₂))+V₁)*V₃=(((01A9−3)*2+(00D2+5)*00C1/(01A9+00D2))+01A9)*00C1=1722B. Then, comparing the operating result X and the mapping table in the BIOS to decide whether the product above has the characteristic value conforming to the usage standards. If the compared result does not conform to the standards, the operating system will be shutdown directly to reach the purpose of protecting the specific program area or data area. Certainly, the operating function above can be changed depending on different situations and settings.

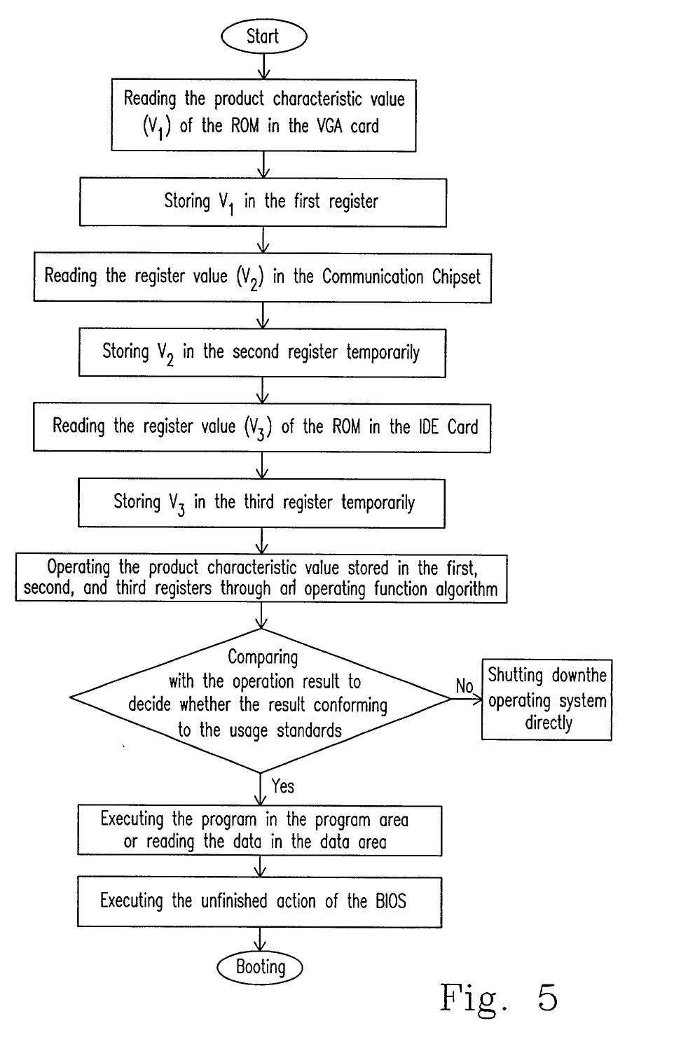

Please refer to FIG. 5 showing the flow chart of the third preferred embodiment according to the present invention. This embodiment shows values read sequentially in the VGA card. The values above include the checksum value of the ROM V₁=0B9, the device ID of the communication chipset V₂=00C3, and the device ID of the IDE card V₃=00A1, and all these values are stored in a register separately. Then, all the product characteristic values in the register are executed with a summing algorithm to obtain the operation result X=V₁+V₂+V₃=01B9+00C3+00A1=31D. Finally, comparing the operating result X and the mapping table in the BIOS to decide whether the product above has the characteristic value conforming to the usage standards. If the compared result does not conform to the standards, the operating system will be shutdown directly to reach the purpose of protecting the specific program area or the data area.

As described above, the method of the present invention can effectively solve the problem about the piracy of the intellectual property that is strenuously developed by the manufacturer to protect some specific program area or data area and prevent the research result from being misappropriated illegally. Consequently, the present invention conforms to the demand of the industry and owns inventiveness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for protecting a specific one of a program area and a dada area having specific usage standards to be applied to a basic input/output system (BIOS), wherein said basic input/output system defines a mapping table therein, said method comprising steps of:
providing at least one product and reading a product characteristic value of said at least one product;
operating said product characteristic value through an algorithm to obtain an operation value;
comparing said operation value with said mapping table to decide whether said at least one product has said characteristic value conforming to said usage standards of said specific one of said program area and said data area; and
executing a protection action for said specific one of said program area and said data area when said at least one product does not have said characteristic value conforming to said usage standards of said specific one of said program area and said data area, thereby preventing said specific one of said program area and said data area from being misappropriated illegally.

2. A method according to claim 1 wherein said product characteristic value is obtained via reading contents of said at least one product.

3. A method according to claim 2 wherein said at least one product is selected from a group consisting of a system chipset, a PCI/ISA card, a ROM, a CMOS, a CPU, a computer peripheral device, and the combination thereof.

4. A method according to claim 3 wherein said system chipset is selected from a group consisting of a clock generator, a South Bridge chipset, a North Bridge chipset, a Communication chipset, a Super I/O chipset, a Video Graphics Array chipset, a small computer system interface chipset, a Local Area network chipset, a sensor chipset, a health chipset, a PCI/PCI Bridge chipset, an IDE ATA Controller chipset, a PCI/ISA Bridge chipset, a 1394 chipset, and the combination thereof.

5. A method according to claim 3 wherein said PCI/ISA card is selected from a group consisting of a sound card, a TV card, a VGA card, a SCSI card, a LAN card, an IDE card, an AMR card, a CNR card, a Modem card, and the combination thereof.

6. A method according to claim 3 wherein said ROM is selected from a group consisting of an EEPROM, an EPROM, a PROM, a ROM, a Flash Memory, and the combination thereof.

7. A method according to claim 6 wherein the product characteristic value of said ROM is based on one data selected from a group consisting of a Checksum value, a Class code, a Sub-class code, a Revision ID, a Device ID, a Vendor ID, a Manufacturer ID, a Product ID, a Sub-Product ID, a Sub-Device ID, a Sub-Vendor ID, a ROM Signature, a Data Structure Length, a Data Structure Revision, an Image Length, a Revision Level of Code/Data, a code Type, a Command Code, a Control Register, a Status Register, an Expansion ROM Base Address, a Configuration type, a Serial Presence Detect Data, a Clockgen device related data, and a specific address data.

8. A method according to claim 3 wherein said CMOS is used for storing a relevant set value of said BIOS.

9. A method according to claim 3 wherein said product characteristic value is selected from a group consisting of an ID, a Patch ID, a relevant register value of said CPU, and combination thereof.

10. A method according to claim 3 wherein said computer peripheral device is selected from a group consisting of a Modem, a Printer, a Serial Port Device, a Parallel port device, a SCSI Device, an IDE Device, a UBS Device, a midi Device, and the combination thereof.

11. A method according to claim 10 wherein said SCSI Device, said IDE Device, and said USB Device are provided by a group consisting one of a diskette, a hard disk, a compact disc, a ZIP disk, a LS-120 disk, a type, and the combination thereof.

12. A method according to claim 11 wherein said product characteristic value is one selected from a group consisting of a register value, an I/O port value and the combination thereof in said at least one product.

13. A method according to claim 1 wherein said algorithm is a secret code algorithm.

14. A method according to claim 13 wherein said secret code algorithm is one of a summing algorithm and an operating function algorithm.

15. A method according to claim 1 wherein said protecting action is to skip said specific one of said program area and said data area.

16. A method according to claim 1 wherein said protecting action is to shutdown the operating system.

17. A method according to claim 1 wherein said protecting action is to halt the operating system.

18. A method according to claim 1 wherein said protecting action is to produce a flag signal to be stored in a storage device for protecting said specific one of said specific program area and data area.

19. A method according to claim 1 wherein said program area and said data area are stored in a storage module.

20. A method according to claim 1 wherein said operation value is one of a specific value and a supplemental value.

21. A method for protecting a specific one of a program area and a dada area having specific usage standards to be applied to a basic input/output system (BIOS), wherein said basic input/output system defines a mapping table therein, said method comprising steps of:
providing at least one product and reading a product characteristic value of said at least one product;
comparing said product characteristic value with said mapping table to decide whether said at least one product has said characteristic value conforming to usage standards of said specific one of said program area and said data area; and
executing a protection action for said specific one of said program area and said data area when said at least one product does not have said characteristic value conforming to said usage standards of said specific one of said program area and said data area, thereby preventing said specific one of said program area and said data area from being misappropriated illegally.
